(19) United States
(12) Patent Application Publication
(10) Pub. No.: US 2025/0175875 A1
(43) Pub. Date: May 29, 2025

(54) TECHNIQUES FOR OPERATING CONDITIONAL HANDOVER AND CONDITIONAL PRIMARY SECONDARY CELL ADDITION OR CHANGE

(71) Applicant: ELECTRONICS AND TELECOMMUNICATIONS RESEARCH INSTITUTE, Daejeon (KR)

(72) Inventors: Sun Mi JUN, Daejeon (KR); IL GYU KIM, Daejeon (KR); Jung-Im KIM, Daejeon (KR); Jun Sik KIM, Daejeon (KR); Soon Gi PARK, Daejeon (KR); Sung Cheol CHANG, Daejeon (KR); Hee Sang CHUNG, Daejeon (KR); Yong Seouk CHOI, Daejeon (KR)

(73) Assignee: ELECTRONICS AND TELECOMMUNICATIONS RESEARCH INSTITUTE, Daejeon (KR)

(21) Appl. No.: 18/964,228

(22) Filed: Nov. 29, 2024

(30) Foreign Application Priority Data
Nov. 29, 2023 (KR) 10-2023-0169869
Oct. 11, 2024 (KR) 10-2024-0138430

(51) Int. Cl. H04W 36/30; H04W 36/00; H04W 36/36

(52) U.S. Cl. CPC H04W 36/30; H04W 36/0069; H04W 36/362

(57) ABSTRACT

Various embodiments are disclosed regarding a technology for operating conditional handover and conditional primary secondary cell addition or change. In one embodiment, a method of operating a terminal in a wireless communication system may comprise: receiving, from a first base station, a first message including configuration information related to conditional handover and secondary cell group change; performing monitoring of a first execution condition for the conditional handover and a second execution condition for the secondary cell group change based on the first message; transmitting, to a second base station, a second message including results of the monitoring; and performing at least one of the conditional handover or the secondary cell group change based on the monitoring and an operation type.

### CROSS REFERENCE TO RELATED APPLICATION

The present application claims priority to Korean Patent Application No. 10-2023-0169869, filed on Nov. 29, 2023, and Korean Patent Application No. 10-2024-0138430, filed on Oct. 11, 2024, the entire contents of which are incorporated herein for all purposes by this reference.

### BACKGROUND

### Technical Field

This disclosure relates to a technology for operating Conditional Handover (CHO) and Conditional Primary Secondary Cell Addition or Change (CPAC), and more particularly, some embodiments relate to a technology for integrated operation of CHO and CPAC procedures.

### Description of the Related Art

With the advancement of information and communication technology, various wireless communication technologies are being developed. Representative wireless communication technologies include LTE (Long Term Evolution) and NR (New Radio) as specified in the 3GPP (3rd Generation Partnership Project) standard. LTE may be one of the 4G (4th Generation) wireless communication technologies, and NR may be one of the 5G (5th Generation) wireless communication technologies.

To handle the surge in wireless data following the commercialization of 4G communication systems (e.g., communication systems supporting LTE), 5G communication systems (e.g., communication systems supporting NR) that use frequency bands higher than those of 4G communication systems (e.g., frequency bands above 6 GHZ) in addition to the frequency bands of 4G communication systems (e.g., frequency bands below 6 GHZ) are being considered. The 5G communication system can support eMBB (enhanced Mobile Broadband), URLLC (Ultra-Reliable and Low Latency Communication), and mMTC (massive Machine Type Communication).

Meanwhile, in a communication system, a terminal may change its connected cell (e.g., base station) through a handover procedure or a cell (re) selection procedure. In the handover procedure, the terminal may measure the strength of signals received from neighboring base stations and report the measurement results to a source base station. The source cell may receive the measurement results from the terminal and, based on these results, select a target base station for the terminal to hand over to. The target cell to which the terminal will hand over may be selected by the source cell. When handover preparation at the target cell selected by the source cell is completed, the source cell may send a handover command message to the terminal, instructing it to hand over to the target cell. Upon receiving the handover command message from the source cell, the terminal may perform a connection procedure with the target cell.

Multi-Radio Dual Connectivity (MR-DC) allows a terminal to perform multiple connections across multiple frequency bands simultaneously. Thus, the terminal may be connected to a master cell group and a secondary cell group with different frequency bands. In multi-radio dual connectivity, to change the secondary cell group, conditional pscell change (CPC) or conditional pscell addition (CPA) may be supported. However, as the number of multiple connections for the terminal increases, the complexity of handovers between master nodes and cell changes between secondary nodes may increase. Accordingly, there may be a need for a method that integrates conditional handover (CHO) and CPAC (conditional pscell addition or change) to reduce complexity.

### SUMMARY

There may be a need for improved technologies for operating CHO and CPAC, or for managing master cell groups and secondary cell groups.

The technical objectives intended to be achieved by the present disclosure are not limited to those mentioned above, and additional technical challenges not explicitly mentioned here may be considered by those skilled in the art to which the technical configuration of this disclosure applies, based on the embodiments described below.

One aspect of this disclosure provides a method of operating a terminal in a wireless communication system. In some embodiments, the method may comprise: receiving, from a first base station, a first message including configuration information related to conditional handover and secondary cell group change; performing monitoring of a first execution condition for the conditional handover and a second execution condition for the secondary cell group change based on the first message; transmitting, to a second base station, a second message including results of the monitoring; and performing at least one of the conditional handover or the secondary cell group change based on the monitoring and an operation type. In some embodiments, the operation type may include a first mode in which the conditional handover and the secondary cell group change are performed simultaneously and a second mode in which the conditional handover and the secondary cell group change are performed sequentially.

In some embodiments, the secondary cell group change may comprise at least one of Conditional PSCell change (CPC) or Conditional PSCell addition (CPA).

In some embodiments, when the operation type is the first mode, the method may further comprise executing a timer for monitoring the first execution condition and the second execution condition.

In some embodiments, when both satisfaction of the first execution condition and satisfaction of the second execution condition are detected through the monitoring before the timer expires, the second base station may be a target master node, and the terminal may perform both the conditional handover and the secondary cell group change. In some embodiments, when satisfaction of the first execution condition is detected and satisfaction of the second execution condition is not detected when the timer expires through the monitoring, the second base station may be a target master node, and the terminal may perform the conditional handover. In some embodiments, when satisfaction of the second execution condition is detected and satisfaction of the first execution condition is not detected when the timer expires through the monitoring, the second base station may be a target secondary node, and the terminal may perform the secondary cell group change.

In some embodiments, performing the monitoring may comprise: detecting radio quality changes related to at least one candidate base station; performing measurement reporting to the first base station; and receiving, from the first base station, reconfiguration information related to the conditional handover and the secondary cell group change.

In some embodiments, when the operation type is the second mode, the conditional handover or the secondary cell group change may be performed sequentially based on the order in which the first execution condition and the second execution condition are satisfied.

In some embodiments, when satisfaction of the first execution condition is detected through the monitoring, the method may further comprise: connecting with the second base station based on the conditional handover; and transmitting, to the second base station, monitoring status information related to the second execution condition. In this case, the second base station may be a target master node.

In some embodiments, when satisfaction of the second execution condition is detected through the monitoring, the method may further comprise: connecting with the second base station based on the secondary cell group change; and transmitting, to the second base station, monitoring status information related to the first execution condition. In this case, the second base station may be a target secondary node.

In some embodiments, the method may further comprise transmitting a third message to the first base station based on the first message. In some embodiments, the first message may include a list of operation types that can be selected by the terminal and priorities between the operation types. In some embodiments, the third message may include information about the operation type selected by the terminal. In some embodiments, the first message may be an RRC (radio resource control) reconfiguration message, and the third message may be an RRC reconfiguration complete message.

In some embodiments, the first message may include information about the operation type selected by the first base station.

In some embodiments, the method may further comprise transmitting, to the first base station, a fourth message including information about the operation type selected by the terminal. In some embodiments, the configuration information may be determined based on the fourth message.

In some embodiments, the operation type may be indicated through an index value.

Another aspect of this disclosure provides a method of operating a first base station in a wireless communication system. In some embodiments, the method may comprise: transmitting a first message including configuration information related to conditional handover and secondary cell group change to a terminal; allocating resources related to the conditional handover and the secondary cell group change; and performing at least one of the conditional handover or the secondary cell group change based on an operation type. In some embodiments, the operation type may include a first mode in which the conditional handover and the secondary cell group change are operated simultaneously and a second mode in which the conditional handover and the secondary cell group change are operated sequentially.

In some embodiments, the secondary cell group change may comprise at least one of Conditional PSCell change (CPC) or Conditional PSCell addition (CPA).

In some embodiments, the method may further comprise: receiving measurement reports related to radio quality changes of at least one candidate base station from the terminal; performing reconfiguration related to the conditional handover and the secondary cell group change based on the measurement reports; and transmitting, to the terminal, information related to the reconfiguration.

In some embodiments, the method may further comprise receiving a third message from the terminal in response to the first message. In some embodiments, the first message may include a list of operation types that can be selected by the terminal and priorities between the operation types, and the third message may include information about the operation type selected by the terminal.

In some embodiments, the first message may include information about the operation type selected by the first base station.

In some embodiments, the method may further comprise receiving, from the terminal, a fourth message including information about the operation type selected by the terminal. In some embodiments, the configuration information may be determined based on the fourth message.

Yet another aspect of this disclosure provides a method of operating a second base station in a wireless communication system. In some embodiments, the method may comprise: receiving, from a first base station, information related to resources and paths for conditional handover and secondary cell group change; receiving, from a terminal, a second message including results of monitoring; performing a random access procedure with the terminal based on the second message; and transmitting a handover complete message to the first base station. In some embodiments, the results of monitoring may be information indicating whether a first execution condition for the conditional handover and a second execution condition for the secondary cell group change are satisfied.

In some embodiments, the secondary cell group change may comprise at least one of Conditional PSCell change (CPC) or Conditional PSCell addition (CPA).

In some embodiments, when the results of monitoring indicate satisfaction of the first execution condition and satisfaction of the second execution condition, the method may further comprise transmitting, to a target secondary node, a message indicating that the conditional handover and the secondary cell group change have been successfully performed. In this case, the first base station may be a source master node, and the second base station may be a target master node.

Yet another aspect of this disclosure provides a communication node (for example, terminal, base station) that performs a method according to at least one of the embodiments of this disclosure. In some embodiments, the communication node may be an electronic device belonging to a wireless communication system and include: a transceiver; a memory; and a processor electrically connected to the transceiver and the memory, wherein the processor can execute at least one instruction stored in the memory to perform a method according to at least one of the embodiments of this disclosure.

Yet another aspect of this disclosure provides a non-transitory recording medium storing instructions readable by a processor of an electronic device, wherein the instructions cause the processor to perform embodiments of this disclosure.

This summary is provided to introduce a selection of concepts in a simplified form that are further described in the detailed description below. This summary is not intended to identify key or essential features of the claimed subject matter, nor is it intended to be used to limit the scope of the claimed subject matter. The claimed subject matter is not limited to implementations that solve any or all disadvantages noted in any part of this disclosure. In addition to the exemplary aspects, embodiments, and features described above, further aspects, embodiments, and features will become apparent from the following detailed description and accompanying drawings.

Some embodiments of this disclosure may have an effect including the following advantages. However, since it is not meant that all exemplary embodiments should include all of them, the scope of the present disclosure should not be understood as being limited thereto.

According to some embodiments, techniques may be provided for efficiently performing conditional handover and conditional secondary cell change procedures in a wireless communication system.

According to some embodiments, techniques may be provided to efficiently support high-density access nodes in a wireless communication system.

According to some embodiments, evaluations for conditional handover and conditional secondary cell change procedures may be performed simultaneously in multi-radio multi-connectivity.

According to some embodiments, techniques may be provided to perform conditional handover and conditional secondary cell change procedures based on a timer in a wireless communication system.

According to some embodiments, techniques may be provided to perform conditional handover and conditional secondary cell change procedures based on an operation type in a wireless communication system.

According to some embodiments, techniques may be provided to allow a terminal or base station to determine the operation type in a wireless communication system.

According to some embodiments, techniques may be provided to perform conditional handover and conditional secondary cell change procedures simultaneously in a wireless communication system.

According to some embodiments, techniques may be provided to perform conditional handover and conditional secondary cell change procedures sequentially in a wireless communication system.

According to some embodiments, techniques may be provided to modify configurations for candidate base stations when the wireless environment changes in a wireless communication system.

### BRIEF DESCRIPTION OF THE DRAWINGS

FIG. 1 illustrates a communication system for explaining some embodiments of this disclosure.

FIG. 2 is a block diagram illustrating a communication node constituting the communication system.

FIG. 3 illustrates an operational environment of multi-band multi-connectivity for explaining some embodiments of this disclosure.

FIG. 4 illustrates an operational environment of CHO and CPAC for explaining some embodiments of this disclosure.

FIG. 5A is a flowchart for explaining some embodiments where a terminal simultaneously performs CHO and CPAC.

FIG. 5B is a flowchart for explaining some embodiments where a base station simultaneously performs CHO and CPAC.

FIG. 6 is a signaling diagram for explaining some embodiments that simultaneously perform CHO and CPAC.

FIG. 7 is a signaling diagram for explaining embodiments of base station-initiated CHO and CPAC procedures.

FIG. 8 is a signaling diagram for explaining embodiments of terminal-initiated CHO and CPAC procedures.

FIG. 9 is a signaling diagram for explaining embodiments where execution conditions for both CHO and CPAC are satisfied.

FIG. 10 is a signaling diagram for explaining embodiments where only the execution condition for CHO is satisfied.

FIG. 11 is a signaling diagram for explaining embodiments where only the execution condition for CPAC is satisfied.

FIG. 12A is a flowchart for explaining some embodiments where a base station sequentially performs CHO and CPAC.

FIG. 12B is a flowchart for explaining some embodiments where a base station sequentially performs CHO and CPAC.

FIG. 13 is a signaling diagram for explaining some embodiments that sequentially perform CHO and CPAC.

### DETAILED DESCRIPTION OF THE DISCLOSURE

Since the description of the present disclosure is merely an exemplary embodiment for structural or functional description, the scope of the present disclosure should not be construed as being limited by the exemplary embodiments described in the text. That is, since exemplary embodiments may be changed in various ways and may have various forms, it should be understood that the right scope of the present disclosure includes equivalents that can realize the technical idea. In addition, the objectives or effects presented in the present disclosure may not mean that a specific exemplary embodiment should include all or only such effects, so the right scope of the present disclosure should not be understood as being limited thereto.

Meanwhile, the meaning of the terms described in the present disclosure should be understood as follows.

Terms such as “first”, “second”, and the like are intended to distinguish one component from another component, and the scope of rights should not be limited by these terms. For example, a first component may be referred to as a second component, and similarly, a second component may also be referred to as a first component.

When a component is referred to as being “connected” to another component, it may be directly connected to the other component, but it should be understood that other components may exist in the middle. On the other hand, when a component is referred to as being “directly connected” to another component, it should be understood that no other component exists in the middle. Meanwhile, other expressions describing the relationship between components, such as “between” and “immediately between” or “neighboring to” and “directly neighboring to”, should be interpreted in the same way.

Singular expressions should be understood to include plural expressions unless the context clearly indicates otherwise, and terms such as “include” or “have” are intended to designate the existence of features, numbers, steps, actions, components, parts, or combinations thereof, and should be understood not to preclude the possibilities of the existence or addition of one or more other features or numbers, steps, actions, components, parts, or combinations thereof.

In each step, identification codes (e.g., a, b, c, etc.) may be used for the convenience of explanation, and identification codes may not describe the order of each step, and each step may occur differently from the specified order unless a specific order is explicitly stated in the context. That is, each step may occur in the same order as the specified order, may be performed substantially simultaneously, or may be performed in the opposite order.

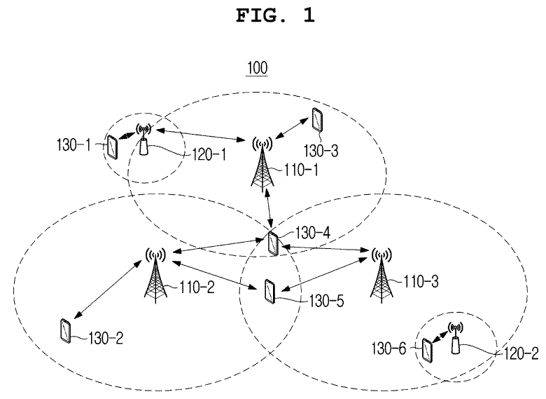

FIG. 1 illustrates a communication system for explaining some embodiments of this disclosure.

Referring to FIG. 1, the communication system (100) may include multiple communication nodes (110-1, 110-2, 110-3, 120-1, 120-2, 130-1, 130-2, 130-3, 130-4, 130-5, 130-6).

The multiple communication nodes may support 4G communications (for example, LTE (Long Term Evolution), LTE-A (Advanced)) and 5G communications (for example, NR (New Radio)) as specified in the 3GPP (3rd Generation Partnership Project) standard.

4G communications may be performed in frequency bands below 6 GHZ, while 5G communications may be performed in frequency bands both below and above 6 GHz.

For example, for 4G and 5G communications, the multiple communication nodes may support communication protocols based on CDMA (Code Division Multiple Access), WCDMA (Wideband CDMA), TDMA (Time Division Multiple Access), FDMA (Frequency Division Multiple Access), OFDM (Orthogonal Frequency Division Multiplexing), Filtered OFDM, CP (Cyclic Prefix)-OFDM, DFT-S-OFDM (Discrete Fourier Transform-spread-OFDM), OFDMA (Orthogonal Frequency Division Multiple Access), SC (Single Carrier)-FDMA, NOMA (Non-orthogonal Multiple Access), GFDM (Generalized Frequency Division Multiplexing), FBMC (Filter Bank Multi-Carrier), UFMC (Universal Filtered Multi-Carrier), SDMA (Space Division Multiple Access), and so forth.

Additionally, the communication system (100) may further include a core network (CN). When the communication system (100) supports 4G communications, the core network may include S-GW (Serving-Gateway), P-GW (PDN (Packet Data Network)-Gateway), MME (Mobility Management Entity), and so forth. When the communication system (100) supports 5G communications, the core network may include UPF (User Plane Function), SMF (Session Management Function), AMF (Access and Mobility Management Function), and so forth. Meanwhile, each of the multiple communication nodes (110-1, 110-2, 110-3, 120-1, 120-2, 130-1, 130-2, 130-3, 130-4, 130-5, 130-6) constituting the communication system (100) may have the following structure.

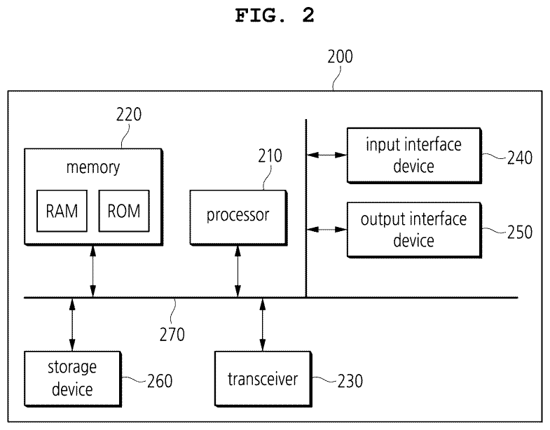

FIG. 2 is a block diagram illustrating a communication node constituting the communication system.

Referring to FIG. 2, the communication node (200) may include at least one processor (210), a memory (220), and a transceiver (230) that performs communication connected to a network.

Additionally, the communication node (200) may further include an input interface device (240), an output interface device (250), and a storage device (260).

Each component included in the communication node (200) may communicate with each other through connection via a bus (270).

However, each component included in the communication node (200) may be connected through individual interfaces or individual buses centered on the processor (210), rather than through the common bus (270). For example, the processor (210) may be connected through a dedicated interface with at least one of the memory (220), the transceiver (230), the input interface device (240), the output interface device (250), and the storage device (260).

The processor (210) may execute program commands stored in at least one of the memory (220) and the storage device (260). The processor (210) may refer to a central processing unit (CPU), a graphics processing unit (GPU), or a dedicated processor on which methods according to embodiments of the present invention are performed. Each of the memory (220) and the storage device (260) may be configured with at least one of volatile storage media and non-volatile storage media. For example, the memory (220) may be configured with at least one of read-only memory (ROM) and random access memory (RAM).

Referring back to FIG. 1, the communication system (100) may include a plurality of base stations (110-1, 110-2, 110-3, 120-1, 120-2) and a plurality of terminals (130-1, 130-2, 130-3, 130-4, 130-5, 130-6). The communication system (100) including the base stations (110-1, 110-2, 110-3, 120-1, 120-2) and terminals (130-1, 130-2, 130-3, 130-4, 130-5, 130-6) may be referred to as an access network. Each of the first base station (110-1), second base station (110-2), and third base station (110-3) may form a macro cell. Each of the fourth base station (120-1) and fifth base station (120-2) may form a small cell.

Within the cell coverage of the first base station (110-1), the fourth base station (120-1), third terminal (130-3), and fourth terminal (130-4) may be located. Within the cell coverage of the second base station (110-2), the second terminal (130-2), fourth terminal (130-4), and fifth terminal (130-5) may be located. Within the cell coverage of the third base station (110-3), the fifth base station (120-2), fourth terminal (130-4), fifth terminal (130-5), and sixth terminal (130-6) may be located. Within the cell coverage of the fourth base station (120-1), the first terminal (130-1) may be located. Within the cell coverage of the fifth base station (120-2), the sixth terminal (130-6) may be located.

In this regard, each of the plurality of base stations (110-1, 110-2, 110-3, 120-1, 120-2) may be referred to as a NodeB, evolved NodeB, base transceiver station (BTS), radio base station, radio transceiver, access point, access node, road side unit (RSU), radio remote head (RRH), transmission point (TP), transmission and reception point (TRP), eNB, gNB, or the like.

Each of the plurality of terminals (130-1, 130-2, 130-3, 130-4, 130-5, 130-6) may be referred to as user equipment (UE), terminal, access terminal, mobile terminal, station, subscriber station, mobile station, portable subscriber station, node, device, Internet of Things (IoT) device, mounted module/device/terminal, on board device/terminal, or the like.

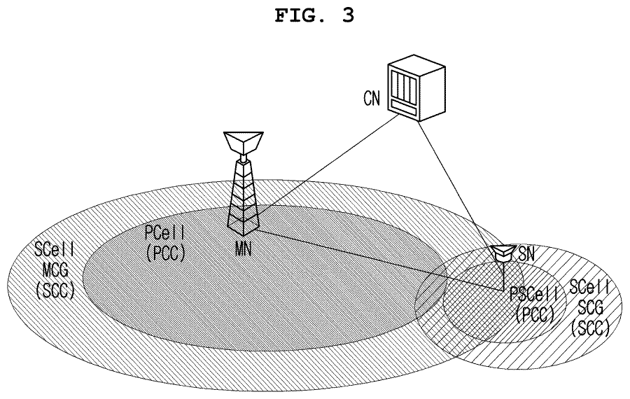

FIG. 3 illustrates an operational environment of multi-band multi-connectivity for explaining some embodiments of this disclosure.

Multi-Radio Multi-Connectivity (MR-DC) is a technology where a single terminal performs multiple simultaneous connections across multiple bands. 3GPP has been conducting research on dual connectivity between FR1 and FR2. The standardization discussed regarding multi-band multi-connectivity is as shown in Table 1 below.

TABLE 1

| | Work Item |
|---|---|
| Rel-12 | The dual connectivity was defined in which the |
| | user terminal is simultaneously connected to two |
| | LTE access nodes connected via a non-ideal |
| | backhaul and configured to utilize the radio |
| | resources provided by each scheduler. |
| Rel-13 | LTE Wi-Fi Aggregation (LWA) technology in which |
| | the user terminal performs a dual connection |
| | simultaneously between LTE and WiFi. |
| Rel-14 | Initiating standardization of 5G systems and |
| | deriving requirements for expansion into MR-DC. |
| Rel-15 | Standardizing NSA MR-DC with simultaneous |
| | connection to LTE and 5G NR in the form of EN-DC, |
| | NGEN-DC, NE-DC. |
| Rel-16 | Support for data splitting and data duplication |
| | transmission at the PDCP layer of MR-DC to meet |
| | Ultra Reliable Low Latency Communication (URLLC). |
| | Support for dual connectivity between NR/NR. |
| | Support for dual connectivity between NR/NR- |
| | Unlicensed. |
| | Efficient method of setting/activating/ |
| | initializing service cells to minimize signaling |
| | overhead and delay. |
| | Supports for fast recovery of Master Cell |
| | Group(MCG) links utilizing Secondary Cell |
| | Group(SCG) links and Signal Radio Bearers (SRBs). |
| Rel-17 | Standardizing MR-DC, focusing on improving |
| | existing functions. |
| | Efficient activation/deactivation mechanisms in |
| | the SCG, Extends the target of conditional |
| | handover to the SCG's Primary Secondary Cell |
| | (PScell) to speed up changes and additional |
| | procedures in the SCG. |

In Rel-17, the CPAC procedure was added for efficient Secondary Cell Group (SCG) management. CPAC includes Conditional PSCell Addition (CPA) and Conditional PSCell Change (CPC). Hereinafter, the procedure for secondary cell group management will be referred to as the secondary cell group change procedure. Here, the CPAC procedure allows a terminal to decide to perform PSCell change/addition or Secondary Node (SN) change/addition when specific conditions are met.

CHO is a procedure that allows a terminal to decide to perform a handover when specific conditions are met. Therefore, when communication conditions in the current cell are poor, the terminal can perform conditional handover for cell change.

Currently, functionality for simultaneously operating conditional handover and multi-band multi-connectivity is being discussed. Specifically, L1/L2 mobility enhancements such as LTM (Low Level Triggered Mobility), where cells can be changed by L1/L2 signaling by improving the serving cell change procedure through L3 measurements and L3 signaling, are being discussed. Various methods can be proposed for this purpose.

In a multi-band multi-connectivity environment, CHO handover and CPAC technology may be operated in combination as follows. CPAC can be performed for secondary cell group changes in a multi-band multi-connectivity environment. CHO may be configured to support multi-band multi-connectivity. That is, CHO including target master cell group and target secondary cell group may be operated. For this purpose, CHO and CPAC may be supported together in a multi-band multi-connectivity environment. However, to reduce signaling overhead, mechanisms may need to be specified for joint evaluation of conditions for CHO and CPAC.

The sub-terahertz band in the 0.1 THz˜0.3 THz range provides high data transmission rates but may have high data loss rates and extremely small coverage areas due to physical constraints of the radio band. These physical constraints may include free-space attenuation, molecular absorption loss, non-line of sight path loss, and so forth. The specific characteristics of sub-6 GHZ, NR (New Radio), and sub-terahertz are as shown in [Table 2] below.

TABLE 2

| | Sub-6 GHz | | NR | | Sub-THz | |
|---|---|---|---|---|---|---|
| Band | 3.5 | GHz | 24~28 | GHz | 0.1~0.3 | THz |
| peak data rate | 1 | Gbps | 20 | Gbps | 1 | Tbps |

| | | | |
|---|---|---|---|
| diffraction | strong | weak | weak |

The goal of 6G services that need to provide sub-terahertz band service must satisfy 99.9% high reliability and low latency performance within 1 ms end-to-end and within 0.4 ms in the wireless section. The 6G network architecture may be an ultra-small cell structure requiring complex coverage design. Furthermore, 6G may support multi-access to Sub-6 GHZ, mmWave, and Sub-THz, and may be operated with master node and secondary node structures. For example, Sub-6 GHZ, which supports the widest coverage, may be operated as a master node, while the relatively unstable mmWave and Sub-THz bands may be operated as secondary nodes.

In an ultra-high-density network with multi-band multi-connectivity structure, a terminal may be multiply connected to master nodes and secondary nodes. Therefore, the complexity of handovers between master nodes and cell changes between secondary nodes that may occur due to terminal movement may increase as the number of terminal multi-connections increases. Accordingly, some embodiments of this disclosure include a system that performs integrated operation of CHO and CPAC.

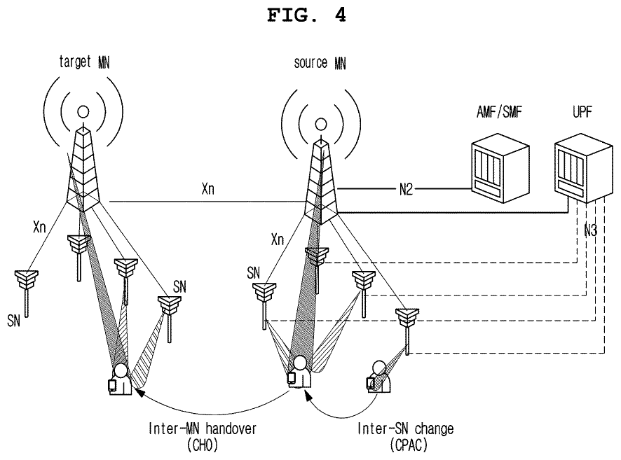

FIG. 4 illustrates an operational environment of CHO and CPAC for explaining some embodiments of this disclosure.

Wireless communication can support multi-band multi-connectivity where communication can be performed by simultaneously connecting to a master node (MN) and secondary node (SN).

Each master node and secondary node may connected to the core network through N2 and N3 interfaces. Fundamentally, since access node properties are not determined by band, operators may determine master nodes and secondary nodes in various ways. For example, operators may set frequency bands with high frequency stability as master nodes and bands with high data transmission rates as secondary nodes.

Hereinafter, terminal movement between secondary nodes is referred to as inter-secondary node change, and movement between master nodes is referred to as inter-master node handover. In a multi-band multi-connectivity environment, at least one of inter-master node handover or secondary cell group change may occur according to terminal movement. Particularly, in high-frequency regions such as sub-terahertz, coverage may not be wide, potentially leading to higher frequency of terminal coverage departures. Therefore, as terminals may experience frequent inter-master node handovers and secondary cell group changes, efficient procedures may be necessary.

Particularly, when CHO operates in a multi-band multi-connectivity environment, secondary node changes may be necessary. However, discussion regarding procedures for performing CPAC together with CHO has not been actively conducted. Some embodiments of this disclosure may use the following methods when user movement occurs in a multi-band multi-connectivity environment:
Method 1: Terminal performs CHO to perform inter-master node handover. [CHO only]
Method 2: Terminal performs CPAC to perform secondary cell group change. [CPAC only]
Method 3: Terminal changes inter-master node handover and secondary cell group change through the same procedure. That is, while CHO is performed, CPAC is not performed as secondary cell group is changed together through CHO.
Method 4: Terminal simultaneously performs CHO and CPAC when performing inter-master node handover and secondary cell group change.

Methods 3 and 4 may have the following differences. In Method 3, during handover or access node change, the terminal performs handover considering inter-master node handover execution conditions and performs candidate secondary group change. In contrast, in Method 4, during handover or access node change, the terminal performs handover and secondary cell group change considering both master node handover execution conditions and secondary cell group change execution conditions. Therefore, Method 4's complexity may be higher than Method 3's.

CHO and CPAC procedures may be performed simultaneously or sequentially. For example, when execution conditions for both CHO and CPAC are satisfied simultaneously, CHO and CPAC procedures may be performed simultaneously. In another example, CHO or CPAC can be performed in the order that their respective execution conditions are satisfied.

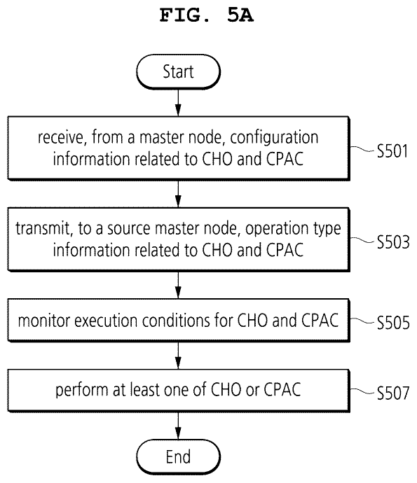

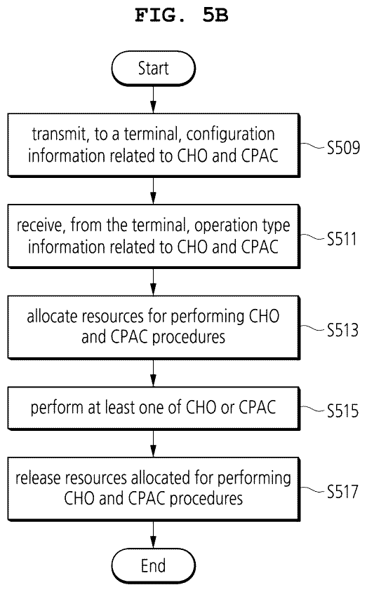

FIG. 5A is a flowchart illustrating some embodiments in which a terminal performs CHO and CPAC simultaneously.

The terminal may receive configuration information for executing CHO and CPAC from a master node (S501). The configuration information may include information about execution conditions for CPAC. The configuration information may be delivered through various messages. For example, the master node may transmit configuration information related to CHO and CPAC through an RRC (radio resource control) reconfiguration message.

The terminal may transmit an operation type related to CHO and CPAC to the master node. For example, the terminal may select an operation type and transmit the selected operation type to the source master node (S503). In some embodiments, the operation type may include a mode where CHO and CPAC are performed simultaneously (hereinafter, simultaneous execution type) and a mode where CHO and CPAC are performed sequentially (hereinafter, sequential execution type).

In some embodiments, the selected operation type may be delivered as an index value.

The selected operation type may be delivered through various messages. For example, the terminal may transmit information about the selected type to the master node through an RRC reconfiguration complete message.

The master node that receives the selected operation type from the terminal may perform configuration of resources and paths for the source master node, source secondary node, target master node, target secondary node, other potential target master nodes, and other potential target secondary nodes.

The terminal may monitor execution conditions for CHO and CPAC (S505). The terminal may set a timer T1 for monitoring and perform evaluation of execution conditions for conditional handover and CPAC.

When conditions for both CHO and CPAC are satisfied simultaneously, the terminal may perform CHO and CPAC simultaneously. Timer T1 may be set to wait until both conditions (i.e., CHO and CPAC) are satisfied simultaneously. In this case, even if one condition satisfied, the terminal waits until the other condition is satisfied, which may result in relatively longer waiting time.

The terminal may perform at least one of CHO or CPAC (S507). For example, the terminal may perform at least one of CHO or CPAC depending on whether the detected parameters satisfy execution conditions for the conditional handover or CPAC, as follows:

First, when execution conditions for both CHO and CPAC are satisfied before timer T1 expires, the terminal may transmit a message including evaluation report to the target master node and perform both CHO and CPAC.

Second, when the execution condition for handover is satisfied but the execution condition for CPAC is not satisfied when T1 expires, the terminal may transmit a message including evaluation report to the target master node and perform CHO. Subsequently, the terminal and master node may release resources associated with CPAC. Therefore, resources related to the target secondary node and other potential target secondary nodes may be released.

Third, when the execution condition for CHO is not satisfied but the execution condition for CPAC is satisfied when T1 expires, the terminal may transmit a message including evaluation report to the target secondary node and perform only CPAC for the secondary node. Subsequently, the terminal, source master node, and secondary node may release resources associated with handover. Therefore, resources associated with the target master node and other potential target master nodes may be released.

Meanwhile, changes in radio quality of candidate master nodes and candidate secondary nodes or candidate PCells and candidate PSCells may occur before timer T1 expires. In some embodiments, when changes in radio quality of candidate master nodes and candidate secondary nodes or candidate PCells and candidate PSCells occur before timer T1 expires, the terminal may perform measurement reporting to the source master node. In this case, configuration for CHO and CPAC may be reconfigured. An example of reconfiguration includes changing the list of candidate master nodes or candidate secondary nodes for CHO and CPAC.

The procedure for changing the list may be performed by either the terminal or the master node. If the procedure is initiated by the terminal, the terminal may deliver a message including a request to change the list of target master node, other potential target master nodes, target secondary node, and other target secondary nodes to the source master node. If initiated by the master node, it may deliver a message including a request to change the list of target master node, other potential target master nodes, target secondary node, and other target secondary nodes to the terminal.

The aforementioned evaluation report and list change request may be transmitted through various messages and are not limited to specific methods. For example, the evaluation report and list change request may be included in RRC reconfiguration messages or RRC reconfiguration complete messages.

FIG. 5B is a flowchart illustrating some embodiments in which a base station performs CHO and CPAC simultaneously.

The base station may transmit configuration information related to CHO and CPAC to the terminal (S509). The configuration information may include information about execution conditions for CPAC. The configuration information may be delivered through various messages. For example, the base station may transmit configuration information related to CHO and CPAC through an RRC reconfiguration message.

The base station may receive an operation type related to CHO and CPAC selected by the terminal from the terminal (S511). In some embodiments, the selected operation type may be delivered as an index value. The selected operation type may be delivered through various messages. For example, the terminal may transmit information about the selected operation type to the master node through an RRC reconfiguration complete message.

The base station that receives the selected operation type from the terminal may perform configuration of resources and paths for the base station, source secondary node, target master node, target secondary node, other potential target master nodes, and other potential target secondary nodes.

The base station may allocate resources for performing CHO and CPAC procedures (S513). The terminal or base station may select or determine an operation type for CHO and CPAC procedures. Based on the determined operation type, the base station may allocate resources and establish paths for CHO. Resource allocation and path establishment for the master node may be performed through a handover request procedure. Additionally, the base station may allocate resources and establish paths for CPAC. Resource allocation and path establishment for the secondary node may be configured through a secondary node addition request procedure.

The base station may perform at least one of CHO or CPAC procedures (S515). For this purpose, the terminal may monitor and evaluate execution conditions for CHO and CPAC, and the target node may receive evaluation reports from the terminal. The terminal, base station, and target node may perform at least one of CHO or CPAC procedures based on the received evaluation report. Here, the target node may be either the target master node or the target secondary node.

The base station may release resources allocated for performing CHO and CPAC procedures (S517). If CHO is executed in S515, the terminal and base station may release resources associated with CPAC. That is, resources related to the target secondary node and other potential target secondary nodes may be released. If CPAC procedure is executed in S515, the terminal, base station, and secondary node may release resources associated with CHO. Therefore, resources associated with the target master node and other potential target master nodes may be released.

If changes in radio quality of candidate master nodes and candidate secondary nodes or candidate PCells and candidate PSCells occur during a specific time period, the terminal may perform measurement reporting to the base station. Consequently, configuration for CHO and CPAC may be reconfigured. An example of reconfiguration includes changing the list of candidate master nodes or candidate secondary nodes for CHO and CPAC.

The procedure for changing the list may be performed by either the terminal or the master node. If the procedure is initiated by the terminal, the terminal may deliver a message including a request to change the list of target master node, other potential target master nodes, target secondary node, and other target secondary nodes to the source master node. If initiated by the master node, it may deliver a message including a request to change the list of target master node, other potential target master nodes, target secondary node, and other target secondary nodes to the terminal.

In the procedure described in FIG. 5B, the specific time period may be modified by the network operator and may be measured by the terminal's timer.

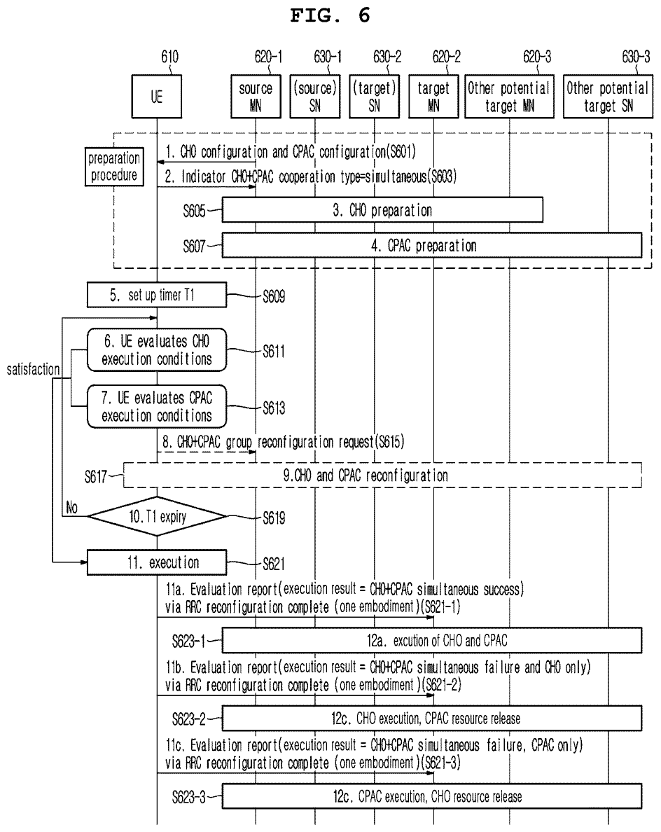

FIG. 6 is a signaling diagram for explaining some embodiments that simultaneously perform CHO and CPAC.

FIG. 6 includes embodiments of procedures performed by the terminal (610) and base station when execution conditions for CHO and CPAC are both satisfied before timer expiration.

The source master node (620-1) may deliver configuration information related to CHO and CPAC to the terminal (610) (S601). The configuration information may include information about operation types for CHO and CPAC. For example, when the terminal (610) determines the operation type, the configuration information may include a list of operation type options that the terminal (610) can select from and their priorities. The operation type option list may include selectable operation types (e.g., simultaneous execution type, sequential execution type). In another example, when the base station determines the operation type, the configuration information may include the operation type selected by the source master node (620-1).

The terminal (610) may store the received configuration information related to CHO and CPAC. As described above, while the operation type can be determined by either the terminal or base station, FIG. 6 describes some embodiments assuming the terminal makes the determination.

The terminal (610), as illustrated in FIG. 6, may decide on simultaneous execution type as the operation type, and the terminal (610) may deliver information about the selected operation type to the source master node (620-1) (S603).

The source master node (620-1) may configure resources and paths for CHO and deliver resource and path information to other nodes (S605). For example, the source master node (620-1) may deliver resource and path information for handover to the target master node (620-2) and other potential target master nodes (620-3).

The source master node (620-1) may configure resources and paths for performing CPAC and deliver resource and path information to other nodes (S607). For example, the source master node (620-1) may deliver resource and path information for performing CPAC to the source secondary node (630-1), target secondary node (630-2), and other potential target secondary nodes (630-3).

The terminal (610) may set up timer T1 for execution conditions of CHO and CPAC (S609). Timer T1 may be used to determine whether both CHO and CPAC execution conditions are satisfied.

The terminal (610) may evaluate execution conditions for CHO (S611) and CPAC (S613). For example, the terminal (610) may perform evaluation of execution conditions while timer T1 is running.

The terminal (610) may measure radio quality related to candidate master nodes and candidate secondary nodes or candidate PCells and candidate PSCells (S615). For example, the terminal (610) may measure radio quality independently from the execution condition evaluation operation.

If radio quality of a specific node deteriorates and cells need to be removed from the CHO candidate list and CPAC candidate list, those nodes may be removed from the candidate list. A cell reconfiguration procedure may be performed for this purpose. For example, the terminal (610) may transmit a cell removal request message to the source master node (620-1) specifying the cells to be removed from the candidate list. The cell removal request message may include measurement information of the cells. In another example, the source master node (620-1) may receive measurement information from the terminal (610) and remove cells from the candidate list. The source master node (620-1) may deliver information about cells removed from the candidate list to the terminal (610) through an RRC reconfiguration procedure.

The decision to add cells to the candidate list may be determined by either the terminal (610) or master node, similar to removal decisions. For example, the terminal (610) may perform discovery and measurement of neighboring cells not included in candidate master nodes and candidate secondary nodes or candidate PCells and candidate PSCells.

When PCells or PSCells with better radio quality are discovered, the terminal (610) may add them to the CHO candidate list and CPAC candidate list. The terminal (610) may transmit measurement information of cells and information about cells to be added to the source master node (620-1), and may request addition of cells to the candidate list by transmitting information about cells to be added to the candidate list.

In another example, the source master node (620-1) may receive measurement information of cells and information about cells to be added from the terminal (610), and the source master node (620-1) may decide to add cells to the candidate list.

The terminal (610) and source master node (620-1) may perform CHO and CPAC reconfiguration procedures (S617). These reconfiguration procedures may be performed if changes to candidate lists are deemed necessary in S615.

The terminal (610) and source master node (620-1) may modify the candidate master node or candidate secondary node lists. For example, to reconfigure the CHO, a handover cancellation procedure may be performed for the candidate target master node (620-2) to be removed. Similarly, to reconfigure CPAC, a secondary node release procedure may be performed for the candidate target secondary node (630-2) to be removed.

The CHO and CPAC reconfiguration procedures may be initiated by either the terminal (610) or source master node (620-1). For example, if the reconfiguration procedure (S617) is initiated by the terminal (610), the terminal (610) may deliver a message including a request to change the lists of target master node (620-2), other potential target master nodes (620-3), target secondary node (630-2), and other target secondary nodes (630-2) to the source master node (620-1). In another example, if the reconfiguration procedure (S617) is initiated by the master node, it may deliver a message including a request to change the lists of target master node (620-2), other potential target master nodes (620-3), target secondary node (630-2), and other potential target secondary nodes (630-3) to the terminal (610). Here, the message for node list changes may be included in an RRC reconfiguration message.

The terminal (610) may detect the expiration of timer T1 and determine whether execution conditions for CHO and CPAC are satisfied when timer T1 expires (S619).

The terminal (610) may perform CHO or CPAC procedures that satisfy execution conditions (S621). Depending on whether execution conditions for CHO and CPAC are satisfied, steps S621-1, S621-2, and S621-3 may be performed.

For example, when the terminal (610) detects that execution conditions for both CHO and CPAC are satisfied before timer T1 expires, the terminal (610) may transmit a message including an evaluation report to the target master node (620-2) (S621-1), and the terminal (610) and nodes may perform CHO and CPAC together.

In another example, when the terminal (610) determines that the execution condition for CHO is satisfied but the execution condition for CPAC is not satisfied when timer T1 expires, the terminal (610) may transmit a message including an evaluation report to the target master node (620-2) (S621-2), and the terminal (610) and nodes may perform CHO for master node change (S623-2). In S623-2, the terminal (610) and master node may release resources associated with CPAC. For example, the terminal (610) and master node may release resources related to the target secondary node (630-2) and other potential target secondary nodes (630-3).

In yet another example, when the terminal (610) determines that the execution condition for CHO is not satisfied but the execution condition for CPAC is satisfied when timer T1 expires, the terminal (610) may transmit a message including an evaluation report to the target master node (620-2) (S621-3), and the terminal (610) and nodes may perform the CPAC procedure (S623-3). For example, the terminal (610) may change the secondary cell group (or secondary node) from 630-1 to 630-2. In S623-3, the terminal (610) and master node may release resources associated with CHO. For example, the terminal (610) and master node may release resources related to the target master node (620-2) and other potential target master nodes (620-3).

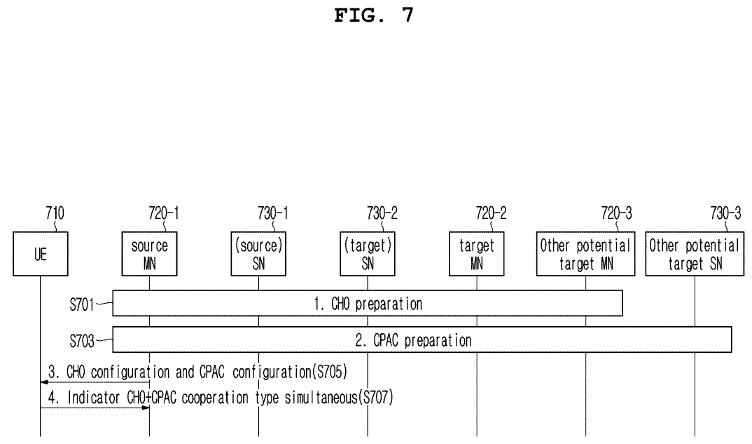

FIG. 7 is a signaling diagram for explaining embodiments of base station-initiated CHO and CPAC procedures.

Referring to FIG. 7, the preparation procedures (S601 to S607) of FIG. 6 may be replaced with the procedures of FIG. 7.

The source master node (720-1) may allocate resources and configure paths for CHO (S701). Resource allocation and path configuration may be performed through a handover request message.

The source master node (720-1) may allocate resources and configure paths for CPAC (S703). Resource allocation and path configuration may be established through a secondary node addition request message.

The source master node (720-1) may transmit configuration information related to CHO and CPAC to the terminal (710) (S705). The method of transmitting configuration information is not limited to a specific procedure. For example, configuration information may be transmitted through an RRC reconfiguration procedure.

The terminal (710) may store the received configuration information and transmit the operation type selected by the terminal (710) for CHO and CPAC to the master node (S707). For example, when the configuration information transmitted in S705 includes an list of operation type options that the terminal (610) can select from and their priorities, the terminal (710) may select the operation type based on this information.

In other embodiments, without performing S707 as illustrated in FIG. 7 (i.e., the terminal selecting the operation type and transmitting the selection result), the base station may determine the operation type and transmit the determined operation type to the terminal by including it in the configuration information (S705).

While the above describes CHO and CPAC procedures being initiated by the base station, the CHO and CPAC procedures may be initiated by the terminal.

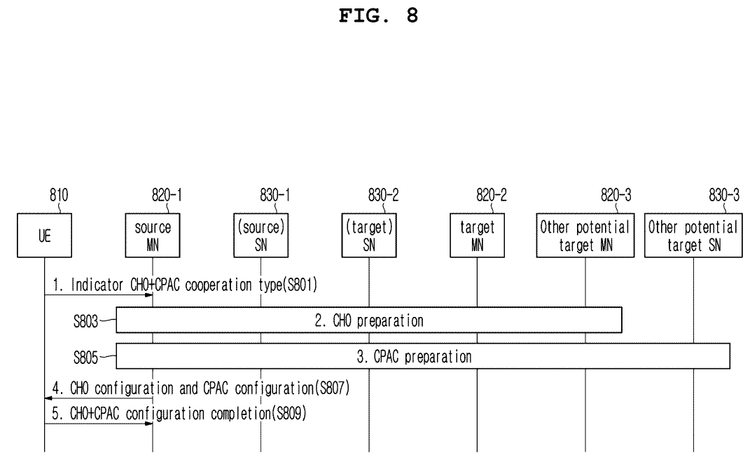

FIG. 8 is a signaling diagram for explaining embodiments of terminal-initiated CHO and CPAC procedures.

Referring to FIG. 8, the preparation procedures (S601 to S607) of FIG. 6 may be replaced with the procedures of FIG. 8.

The terminal (810) can determine the operation type for CHO and CPAC and transmit it to the source master node (820-1) (S801). For example, simultaneous execution type or sequential execution type may be selected as the operation type, and this information may be transmitted through an RRC reconfiguration procedure.

The source master node (820-1) may allocate resources and configure paths for CHO (S803). Resource allocation and path configuration may be performed through a handover request procedure.

The source master node (820-1) can allocate resources and configure paths for CPAC (S805). Resource allocation and path configuration may be established through a secondary node addition request procedure.

The source master node (820-1) may transmit configuration information related to CHO and CPAC to the terminal (810) (S807). The method of transmitting configuration information is not limited to a specific procedure. For example, operation type information and configuration information may be transmitted through an RRC reconfiguration procedure.

The terminal (810) may store the received configuration information and transmit a configuration complete message to the master node (S809).

The following describes the signaling of procedures performed when both execution conditions for CHO and CPAC are satisfied, when only the CHO execution condition is satisfied, and when only the CPAC execution condition is satisfied.

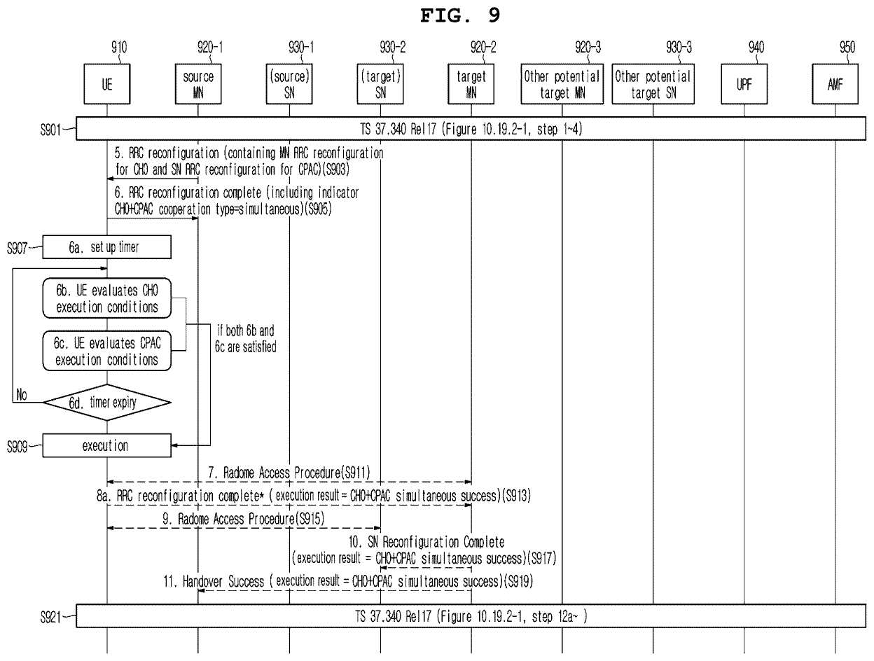

FIG. 9 is a signaling diagram for explaining embodiments where execution conditions for both CHO and CPAC are satisfied.

Each node may perform preparation procedures (S901). The source master node (920-1) may initiate an Xn handover preparation procedure with master cell group configuration and perform secondary cell group configuration to execute the CHO procedure.

When a candidate master node decides to maintain UE context in the secondary node, it may transmit a secondary node addition request message to the secondary node. Additionally, when the candidate master node decides to change to a secondary node that allows delta configuration modifying only changed portions, the candidate master node may transmit a secondary node addition request message including the UE context of the source secondary node (930-1) configured by the source master node (920-1). The secondary node may transmit a secondary node addition request acknowledgment message in response to the secondary node addition request message.

The candidate master node may include a master node RRC reconfiguration message to be transmitted to the terminal (910) for performing CHO in the handover request acknowledgment message. Additionally, the candidate master node may provide a forwarding address to the source master node (920-1). When the candidate master node and secondary node decide to maintain UE context within the secondary node, the candidate master node may forward the UE context to the master node.

The source master node (920-1) may deliver configuration information related to CHO and CPAC to the terminal (910) (S903). The configuration information may include information about operation type. For example, the configuration information may include a list of operation type options that the terminal (910) can select from and their priorities.

The terminal (910) may transmit an RRC reconfiguration complete message to the master node (S905). The RRC reconfiguration complete message may include information about the operation type selected by the terminal (910). The terminal (910) may transmit the RRC reconfiguration complete message indicating an operation type in which CHO and CPAC are performed simultaneously.

The terminal (910) may set up timer T1 for execution conditions of CHO and CPAC and perform evaluation of execution conditions (S907). Timer T1 may be used to determine whether both CHO and CPAC execution conditions are satisfied. The terminal (910) may evaluate execution conditions for CHO and CPAC until timer T1 expires. In FIG. 9, execution conditions for CHO and CPAC may be determined independently, and the order of determination may be changed. Additionally, through evaluation of execution conditions, the target master node (920-2) for CHO and target secondary node (930-2) for CPAC procedure may be determined. As described in S615 of FIG. 6, if communication quality for nodes changes before the timer expires, configuration for CHO and CPAC procedures may be modified.

The terminal (910) may determine whether to perform CHO and CPAC procedures (S909). If execution conditions for both CHO and CPAC are satisfied, the terminal (910) may perform CHO and CPAC procedures. If timer T1 has not expired, the terminal (910) may continue evaluating execution conditions for CHO and CPAC and wait until both are satisfied.

The target master node (920-2) and terminal (910) may perform a random access procedure (S911). Through the random access procedure, the target master node (920-2) and terminal (910) may perform synchronization.

The terminal (910) may transmit an RRC reconfiguration complete message to the target master node (920-2) (S913). The RRC reconfiguration complete message may indicate that CHO and CPAC have been successfully performed simultaneously.

The terminal (910) may perform a random access procedure with the target secondary node (930-2) (S915). Through the random access procedure, the target secondary node (930-2) and terminal (910) may perform synchronization.

The target master node (920-2) may transmit a secondary node reconfiguration complete message to the target secondary node (930-2) (S917). The secondary node reconfiguration complete message may indicate that CHO and CPAC have been successfully performed simultaneously.

The target master node (920-2) may transmit a handover complete message to the source master node (920-1) (S919). The handover complete message may indicate that CHO and CPAC have been successfully performed simultaneously.

The nodes may perform a connection release procedure (S921). The source master node (920-1) may transmit an SgNB release request message to the source secondary node (930-1), and the source secondary node (930-1) may transmit an SgNB release request acknowledgment message. The source master node (920-1) may notify that CHO has been completed by transmitting handover cancellation messages to other potential target master nodes (920-3). The target master node (920-2) and other potential target master nodes (920-3) may transmit SgNB release requests to other potential target secondary nodes (930-3) and receive SgNB release request responses from the target secondary node (930-2).

In this disclosure, while it is described that in S913 and S915, the terminal (910) performs a random access procedure with the target master node (920-2) and the terminal (910) performs a random access procedure with the target secondary node (930-2), it is not limited to a specific order. For example, S915 may be performed before S913.

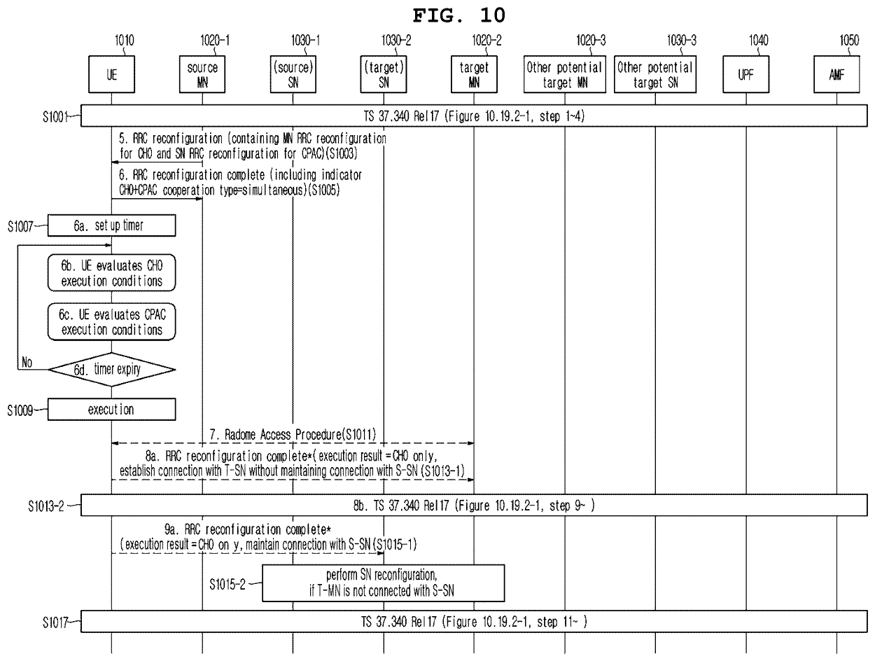

FIG. 10 is a signaling diagram for explaining embodiments where only the execution condition for CHO is satisfied.

Each node may perform preparation procedures (S1001). The source master node (1020-1) may initiate Xn handover preparation procedures with master cell group configuration and perform secondary cell group configuration for executing CPAC procedures.

When the candidate master node decides to maintain UE context in the secondary node, it may transmit a secondary node addition request message to the secondary node. Additionally, when the candidate master node decides to change to a secondary node that allows delta configuration that modifies only changed parts, the candidate master node may transmit a secondary node addition request message including the UE context of the source secondary node (1030-1) configured by the source master node (1020-1). The secondary node may transmit a secondary node addition request acknowledgment message in response to the secondary node addition request message.

The candidate master node may include a master node RRC reconfiguration message to be transmitted to the terminal (1010) for performing CHO in the handover request acknowledgment message. Additionally, the candidate master node may provide a forwarding address to the source master node (1020-1). When the candidate master node and secondary node decide to maintain UE context within the secondary node, the candidate master node may transmit the UE context to the master node.

The source master node (1020-1) may transmit configuration information related to CHO and CPAC to the terminal (1010) (S1003). The configuration information can include information about an operation type. For example, the configuration information can include an list of operation type options that the terminal (1010) can select from and their priorities.

The terminal (1010) may transmit an RRC reconfiguration complete message to the master node (S1005). The RRC reconfiguration complete message may information about the operation type selected by the terminal (1010) for CHO and CPAC. For instance, the terminal (1010) may transmit the RRC reconfiguration complete message to indicate an operation type in which CHO and CPAC are performed simultaneously.

The terminal (1010) may set up timer T1 for execution conditions of CHO and CPAC and perform evaluation of execution conditions (S1007). Timer T1 may be used to determine whether both CHO and CPAC execution conditions are satisfied. The terminal (1010) may evaluate execution conditions for CHO and CPAC until timer T1 expires. In FIG. 10, execution conditions for CHO and CPAC may be determined independently, and the order of determination may be changed. Additionally, through evaluation of execution conditions, the target master node (1020-2) for CHO and target secondary node (1030-2) for CPAC may be determined. As described in S615 of FIG. 6, if communication quality for nodes changes before timer expiration, configurations for CHO and CPAC procedures may be modified.

The terminal (1010) may determine whether to perform CHO and CPAC procedures (S1009). If timer T1 has expired but only the execution condition for CHO is satisfied, the terminal (1010) may perform the CHO procedure. Therefore, if timer T1 has not expired, the terminal (1010) may continue evaluating execution conditions for CHO and CPAC.

The target master node (1020-2) and terminal (1010) may perform random access procedures (S1011). Through the random access procedure, the target master node (1020-2) and terminal (1010) may perform synchronization.

In some embodiments, after S1011, procedures according to S1013-1 and S1013-2 may be performed. In other embodiments, after S1011, procedures according to S1015-1 and S1015-2 may be performed.

The terminal (1010) may transmit an RRC reconfiguration complete message to the target master node (1020-2) (S1013-1). The RRC reconfiguration complete message may indicate that CHO has been successfully performed and that the connection with the source secondary node (1030-1) is not maintained, while connection with the target secondary node (1030-2) has been established.

The nodes may perform cell release procedures (S1013-2). If bearers requiring secondary cell group radio resources are configured, the terminal (1010) may perform synchronization with the target secondary node (1030-2). If the RRC connection reconfiguration procedure is successfully performed, the target master node (1020-2) may notify the target secondary node (1030-2) of completion through an SN reconfiguration complete message. The target master node (1020-2) may notify the source master node (1020-1) through a handover complete message that the terminal (1010) has successfully connected with the target cell. The source master node (1020-1) may transmit an SgNB release request to the source secondary node (1030-1), and the source secondary node (1030-1) may transmit an SgNB release request acknowledgment message. The source master node (1020-1) may notify other potential target master nodes (1020-3) of CHO completion by transmitting handover cancellation messages. The target master node (1020-2) and other potential target master nodes (1020-3) may transmit SgNB release requests to other potential target secondary nodes (1030-3) and receive SgNB release request responses from the target secondary node (1030-2).

The terminal (1010) may transmit an RRC reconfiguration complete message to the target master node (1020-2) (S1015-1). The RRC reconfiguration complete message may indicate that CHO has been successfully performed and that the connection with the source secondary node (1030-1) is maintained.

If the target master node (1020-2) is not connected with the source secondary node (1030-1), the terminal (1010) and target node may perform secondary node reconfiguration procedures (S1015-2).

The nodes may perform connection release procedures (S1017). The target master node (1020-2) may notify the source master node (1020-1) through a handover success message that the terminal (1010) has successfully connected with the target cell. The source master node (1020-1) may transmit an SgNB release request to the source secondary node (1030-1), and the source secondary node (1030-1) may transmit an SgNB release request acknowledgment message. The source master node (1020-1) may notify other potential target master nodes (1020-3) of CHO completion by transmitting handover cancellation messages. The target master node (1020-2) and other potential target master nodes (1020-3) may transmit SgNB release requests to other potential target secondary nodes (1030-3) and receive SgNB release request responses from the target secondary node (1030-2).

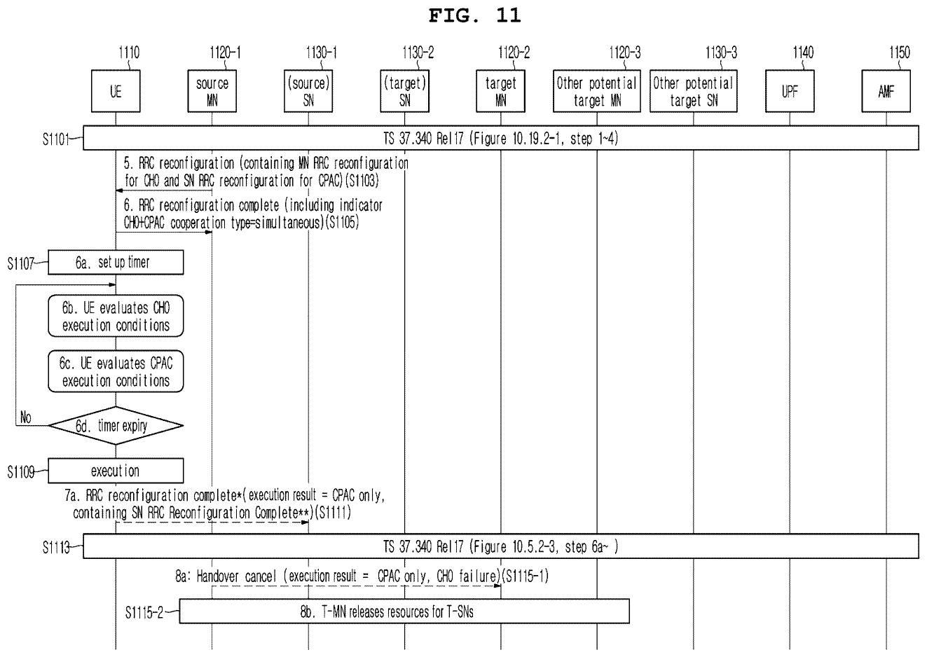

FIG. 11 is a signaling diagram for explaining embodiments where only the execution condition for CPAC is satisfied.

Each node may perform preparation procedures (S1101). The source master node (1120-1) may initiate an Xn handover preparation procedure with master cell group configuration and perform secondary cell group configuration to execute the CPAC procedure.

When a candidate master node decides to maintain UE context in the secondary node, it may transmit a secondary node addition request message to the secondary node. Additionally, when the candidate master node decides to change to a secondary node that allows delta configuration modifying only changed portions, the candidate master node may transmit a secondary node addition request message including the UE context of the source secondary node (1130-1) configured by the source master node (1120-1). The secondary node may transmit a secondary node addition request acknowledgment message in response to the secondary node addition request message.

The candidate master node may include a master node RRC reconfiguration message to be transmitted to the terminal (1110) for performing conditional handover in the handover request acknowledgment message. Additionally, the candidate master node may provide a forwarding address to the source master node (1120-1). When the candidate master node and secondary node decide to maintain UE context within the secondary node, the candidate master node may forward the UE context to the master node.

The source master node (1120-1) may deliver configuration information related to conditional handover and CPAC to the terminal (1110) (S1103). The configuration information may include information about an operation type for conditional handover and CPAC. For example, the configuration information may include a list of operation type options that the terminal (1110) can select from and their priorities.

The terminal (1110) may transmit an RRC reconfiguration complete message to the master node (S1105). The RRC reconfiguration complete message may include information about the operation type selected by the terminal (1110) for CHO and CPAC. For instance, the terminal (1110) may transmit the RRC reconfiguration complete message indicating an operation type where CHO and CPAC are performed simultaneously.

The terminal (1110) may set up timer T1 for execution conditions of CHO and CPAC and perform evaluation of execution conditions (S1107). Timer T1 may be used to determine whether both CHO and CPAC execution conditions are satisfied. The terminal (1110) may evaluate execution conditions for CHO and CPAC until timer T1 expires. In FIG. 11, execution conditions for CHO and CPAC may be determined independently, and the order of determination may be changed. Additionally, through evaluation of execution conditions, the target master node (1120-2) for CHO and target secondary node (1130-2) for CPAC may be determined. As described in S615 of FIG. 6, if communication quality for nodes changes before the timer expires, configuration for CHO and CPAC procedures may be modified.

The terminal (1110) may determine whether to perform CHO and CPAC procedures. If timer T1 has expired and only the execution conditions for CPAC are satisfied, the terminal (1110) may perform the CPAC procedure (S1109). If timer T1 has not expired, the terminal (1110) may continue evaluating execution conditions for CHO and CPAC.

The terminal (1110) may transmit an RRC reconfiguration complete message to the source secondary node (1130-1) (S1111). The RRC reconfiguration complete message may indicate that only CPAC has been successfully performed and may include an SN reconfiguration complete message. Thus, the terminal (1110) may inform the source secondary node (1130-1) that SN reconfiguration has been completed.

The source master node (1120-1) may perform a connection release procedure for the source secondary node (1130-1) (S1113). The source master node (1120-1) may transmit a secondary node release request message to inform the source secondary node (1130-1) to stop providing user data to the terminal (1110). The source secondary node (1130-1) may transmit a secondary node request acknowledgment message to the source master node (1120-1) in response to the secondary node release request message. Additionally, an Xn-U address indication procedure may be triggered, and the source master node (1120-1) may notify the source secondary node (1130-1) of the address of the selected candidate PSCell's secondary node to begin data forwarding.

The source master node (1120-1) may transmit a handover cancellation message to the target master node (1120-2) (S1115-1). The handover cancellation message may indicate that the terminal (1110) has performed CPAC but the CHO has failed. The target master node (1120-2) may perform a radio resource release procedure for the target secondary node (1130-2) (S1115-2).

While the procedures described in FIGS. 5 through 11 describe procedures where CHO and CPAC procedures are processed simultaneously, the CHO and CPAC procedures may be performed sequentially. When CHO and CPAC procedures are performed sequentially, the terminal may move to the master node and secondary node sequentially. While the terminal evaluates CHO execution conditions and CPAC execution conditions, if only one condition is satisfied, it may first perform one procedure and continue evaluation until the remaining execution condition is satisfied.

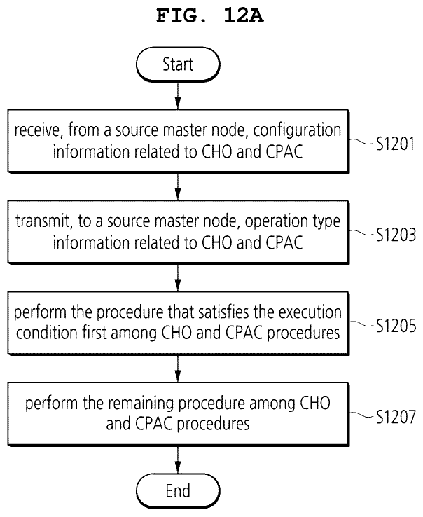

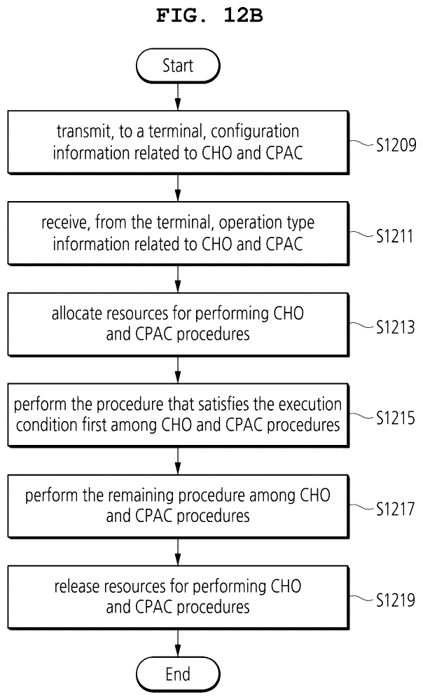

FIG. 12A is a flowchart for explaining some embodiments where a base station sequentially performs CHO and CPAC.

The terminal may receive configuration information for CHO and CPAC from a master node (S1201). The executing configuration information may include information about execution conditions for CPAC. The configuration information may be delivered through various messages. For example, the master node may transmit configuration information related to CHO and CPAC through an RRC reconfiguration message.

The terminal may select an operation type related to CHO and CPAC and transmit the selected operation type to the source master node (S1203). Here, the selected operation type may be delivered as an index value. The operation type may be delivered through various messages. For example, the terminal may transmit information about the selected operation type to the master node through an RRC reconfiguration complete message. The master node that receives the selected operation type from the terminal may perform configuration of resources and paths for the source master node, source secondary node, target master node, target secondary node, other potential target master nodes, and other potential target secondary nodes.

The terminal may perform the procedure that satisfies the execution condition first among the CHO and CPAC procedures (S1205). For example, when the execution condition for CHO is satisfied first, the terminal may perform CHO and move the connection from the source master node to the target master node. The terminal may deliver a message to the target master node including status information indicating that it is evaluating the execution condition for CPAC. The status information may be delivered through an RRC reconfiguration procedure.

The terminal may perform the remaining procedure among CHO and CPAC procedures (S1207). For example, the terminal may perform the CPAC procedure. For this purpose, the terminal may maintain connection with the source secondary node and continue performing CPAC evaluation. The target master node may maintain resources for the target secondary node and other potential target secondary nodes related to CPAC. Subsequently, when the CPAC execution condition is satisfied, the terminal may perform CPAC.

Unlike the above description, when the CPAC execution condition is satisfied first, S1205 and S1207 may be performed differently from the above case (where CHO execution condition is satisfied first).

In S1205, the terminal may perform CPAC to move from the source secondary node to the target secondary node. The terminal may deliver a message to the source master node including status information indicating that it has completed CPAC and is evaluating the execution condition for CHO. The status information may be delivered through an RRC reconfiguration procedure.

The terminal may perform the remaining procedure between CHO and CPAC procedures (S1207). Therefore, the terminal may perform the CHO procedure. For this purpose, the target master node and potential target master nodes associated with CHO may maintain resources for handover. The terminal may maintain connections with source master nodes and continue performing CHO evaluation. When the execution condition for CHO is satisfied, the terminal may move from the source master node to the target master node.

FIG. 12B is a flowchart for explaining some embodiments where a base station sequentially performs CHO and CPAC.

The base station may transmit configuration information regarding CHO and CPAC to a terminal (S1209). The configuration information may include information about execution conditions for CPAC. The configuration information may be transmitted through various messages. For example, the base station may transmit configuration information regarding CHO and CPAC through an RRC reconfiguration message.

The base station may receive from the terminal an operation type selected by the terminal regarding CHO and CPAC (S1211). Here, the selected type may be transmitted as an index value. The selected operation type may be transmitted through various messages. For example, the base station may receive information about the selected operation type through an RRC reconfiguration complete message from the terminal.

Upon receiving the selected operation type from the terminal, the base station may configure resources and paths for the base station, source secondary node, target master node, target secondary node, other potential target master nodes, and other potential target secondary nodes.

The base station may allocate resources to perform CHO and CPAC procedures (S1213). The terminal or base station may determine an operation type for CHO and CPAC procedures. Based on the determined operation type, the base station may allocate resources and establish paths for handover. Resource allocation and path establishment for the master node may be performed through a handover request procedure. Additionally, the base station may allocate resources and establish paths for CPAC. Resource allocation and path establishment for the secondary node may be configured through a secondary node addition request procedure.

The base station may perform the procedure that first satisfies the execution conditions among CHO and CPAC procedures (S1215). The terminal may monitor and evaluate the execution conditions for CHO and CPAC. Accordingly, the target node may receive evaluation reports from the terminal. Based on the received evaluation reports, the target node may perform at least one of the CHO or CPAC procedures. For example, the terminal, base station, and target node may first perform the CHO procedure. Here, the target node may become the target master node or target secondary node.

The base station may perform the remaining procedure among the CHO and CPAC procedures (S1217). If the CHO procedure is performed first, the terminal may maintain connection with the source secondary node and continue performing CPAC evaluation. The target master node may maintain resources for the target secondary node and other potential target secondary nodes related to CPAC. Subsequently, if the CPAC execution conditions are satisfied, the terminal and base station may perform CPAC.

The base station may release resources allocated for performing CHO and CPAC procedures (S1219). If handover execution conditions are satisfied but CPAC execution conditions are not satisfied, the terminal may transmit a message including an evaluation report to the target master node and perform handover. Subsequently, the terminal and base station may release resources associated with CPAC. Accordingly, resources related to the target secondary node and other potential target secondary nodes may be released.

If CHO execution conditions are not satisfied but CPAC execution conditions are satisfied, the terminal may transmit a message including an evaluation report to the target secondary node. Subsequently, the terminal and base station may release resources associated with CHO. Accordingly, resources associated with the target master node and other potential target master nodes may be released.

If radio quality changes occur in candidate master nodes and candidate secondary nodes or candidate PCells and candidate PSCells during the execution of steps S1209 and S1215, the terminal may perform measurement reporting to the base station. Accordingly, configurations regarding CHO and CPAC may be reconfigured. At this time, a procedure for changing the list of candidate master nodes for CHO or candidate secondary nodes for CPAC may be initiated by either the terminal or base station.

If the procedure is initiated by the terminal, the terminal may transmit a message to the base station including a request to change the list of target master nodes, other potential target master nodes, target secondary nodes, and other target secondary nodes. If the procedure is initiated by the base station, it may transmit a message to the terminal including a request to change the list of target master nodes, other potential target master nodes, target secondary nodes, and other target secondary nodes.

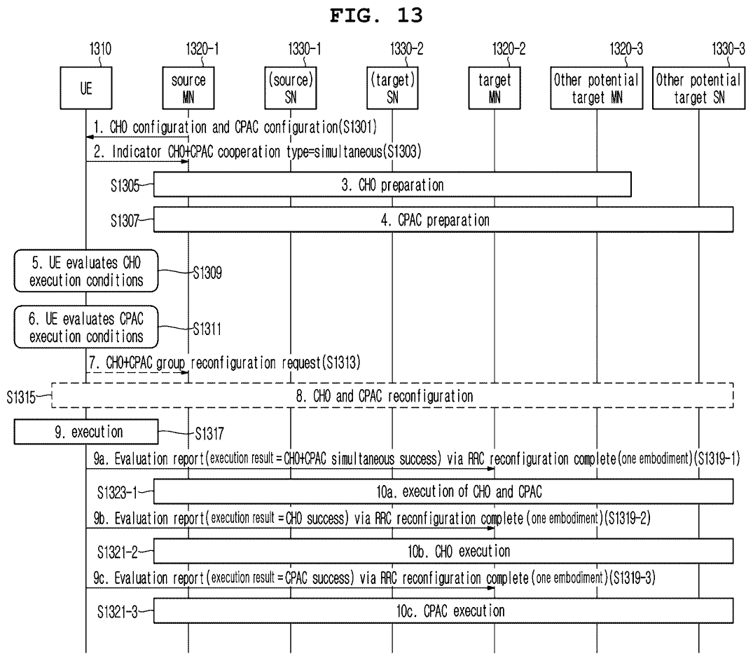

FIG. 13 is a signaling diagram for explaining some embodiments that sequentially perform CHO and CPAC.

The source master node (1320-1) may transmit configuration information regarding CHO and CPAC to the terminal (1310) (S1301). The configuration information may include information about an operation type for CHO and CPAC. For example, the configuration information may include a list of operation type options for CHO and CPAC that the terminal (1310) can select, along with their priorities. In another example, the configuration information may include an integrated operation type for CHO and CPAC selected by the source master node (1320-1).

The configuration information may be transmitted through an RRC reconfiguration procedure.

The operation types may comprise a mode where CHO and CPAC are performed simultaneously, and a mode where they are performed sequentially.

The terminal (1310) may store the received configuration information regarding CHO and CPAC, and transmit information about the selected operation type to the source master node (1320-1) (S1303). Here, the operation type information may be transmitted as an index. In FIG. 13, it is assumed that the terminal (1310) has selected an operation type where CHO and CPAC are performed sequentially.

The source master node (1320-1) may configure resources and paths for CHO and share this information with other nodes (S1305). For example, the source master node (1320-1) may transmit information about the resources and paths for handover to the target master node (1320-2) and other potential target master nodes (1320-3). The information about the resources and paths for CHO may be included in a handover request message but is not limited to any specific method.

The source master node (1320-1) may configure resources and paths for performing CPAC and share this information with other nodes (S1307). For example, the source master node (1320-1) may transmit information about resources and paths for secondary node addition requests to the source secondary node (1330-1), target secondary node (1330-2), and other potential secondary nodes.

The terminal (1310) may evaluate the execution conditions for CHO (S1309) and CPAC (S1311).

The terminal (1310) may measure radio quality for candidate master nodes and candidate secondary nodes or candidate PCells and candidate PSCells (S1313). For example, during execution condition evaluation, the terminal (1310) may perform radio quality measurements. If the radio quality of a specific node deteriorates such that cells need to be removed from the CHO candidate list and CPAC candidate list, those nodes may be removed from the candidate list. The candidate list reconfiguration may be initiated by either the terminal (1310) or the base station. For example, the terminal (1310) may transmit a cell removal request message to the source master node (1320-1) for cells to be removed from the candidate list. The cell removal request message may include measurement information for the cells. In another example, the source master node (1320-1) may receive at least one of measurement information or cell addition information from the terminal (1310) and add cells to the candidate list. The source master node (1320-1) may transmit information about cells removed from the candidate list through an RRC reconfiguration message.

The terminal (1310) and source master node (1320-1) may perform CHO and CPAC reconfiguration procedures (S1315). These reconfiguration procedures may be performed if changes to the candidate lists are deemed necessary in S1313. The terminal (1310) and source master node (1320-1) may modify the candidate master node or candidate secondary node lists. For example, the source master node (1320-1) may perform a handover release procedure with the candidate target master node (1320-2) to be removed for CHO reconfiguration. In another embodiment, the source master node (1320-1) may perform a secondary node release procedure with the candidate target secondary node (1330-2) to be removed for CPAC reconfiguration.

The CHO and CPAC reconfiguration procedures may be initiated by either the terminal (1310) or source master node (1320-1). For example, if the reconfiguration procedure is initiated by the terminal (1310), the terminal (1310) may transmit a message to the source master node (1320-1) including a request to change the lists of target master node (1320-2), other potential target master nodes (1320-3), target secondary node (1330-2), and other target secondary nodes (1330-2). In another example, if the reconfiguration procedure is initiated by the master node, it may transmit a message to the terminal (1310) including a request to change the lists of target master node (1320-2), other potential target master nodes (1320-3), target secondary node (1330-2), and other target secondary nodes (1330-2). Here, the message for node list modification may be included in an RRC reconfiguration message.

The terminal (1310) may perform either the CHO or CPAC procedure that satisfies the execution conditions (S1317). Depending on whether the execution conditions for CHO and CPAC are satisfied, S1319-1, S1319-2, and S1319-3 may be performed.

If execution conditions for both CHO and CPAC are satisfied, the terminal (1310) may transmit a message including an evaluation report to the target master node (1320-2) (S1319-1), and the terminal (1310) and nodes may perform CHO and CPAC together (S1321-1).

If the execution conditions for CHO are satisfied but CPAC execution conditions are not satisfied, the terminal (1310) may transmit a message including an evaluation report to the target master node (1320-2) (S1319-2), and the terminal (1310) and nodes may perform CHO for master node change. In S1319-2, the terminal (1310) and master node may release resources associated with CPAC. For example, the terminal (1310) and master node may release resources related to the target secondary node (1330-2) and other potential target secondary nodes (1330-3).

If the execution conditions for CHO are not satisfied but CPAC execution conditions are satisfied, the terminal (1310) may transmit a message including an evaluation report to the target master node (1320-2) (S1319-3), and the terminal (1310) and nodes may perform the CPAC procedure (S1321-3). In S1321-3, the terminal (1310) and master node may release resources associated with CHO. For example, the terminal (1310) and master node may release resources related to the target master node (1320-2) and other potential target master nodes (1320-3).

While FIGS. 5 through 13 describe methods using the CPAC procedure for convenience of explanation, the procedure for changing secondary cell groups is not necessarily limited to the CPAC procedure. Therefore, CPAC may be replaced with other procedures for changing secondary cell groups.

In a multi-band multi-connectivity environment using sub-terahertz bands, a mobile communication system supporting high-density access nodes may be necessary to satisfy conditions requiring low latency while providing multimedia high-capacity services and ensuring user mobility. To this end, 3GPP has added CHO functionality for master node handover or CPAC functionality for secondary cell group changes, but when operated independently, excessive signaling and latency may occur.

Therefore, this disclosure includes embodiments that can simultaneously support CHO and CPAC in multi-band multi-connectivity. In some embodiments, evaluation of CHO and CPAC may be performed simultaneously, reducing signaling complexity. Some embodiments may determine appropriate waiting times for integrated execution of CHO and CPAC, and perform procedures that satisfy conditions if the waiting time is exceeded. Also, in some embodiments, the master node may reduce signaling and latency by releasing resources of access nodes that do not satisfy conditions. Additionally, in some embodiments, the terminal and source master node may share and modify new candidate lists to replace access nodes that do not satisfy conditions, allowing the terminal to perform CHO and CPAC procedures through the new candidate lists.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random-access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above-described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

What is claimed is:

1. A method of operating a terminal in a wireless communication system, comprising:
receiving, from a first base station, a first message including configuration information related to conditional handover and secondary cell group change;
performing monitoring of a first execution condition for the conditional handover and a second execution condition for the secondary cell group change based on the first message;
transmitting, to a second base station, a second message including results of the monitoring; and
performing at least one of the conditional handover or the secondary cell group change based on the monitoring and an operation type,
wherein the operation type includes a first mode in which the conditional handover and the secondary cell group change are performed simultaneously and a second mode in which the conditional handover and the secondary cell group change are performed sequentially.

2. The method of claim 1, wherein the secondary cell group change comprises at least one of Conditional PSCell change (CPC) or Conditional PSCell addition (CPA).

3. The method of claim 1, wherein when the operation type is the first mode, the method further comprises executing a timer for monitoring the first execution condition and the second execution condition.

4. The method of claim 3, wherein:
when both satisfaction of the first execution condition and satisfaction of the second execution condition are detected through the monitoring before the timer expires, the second base station is a target master node, and the terminal performs both the conditional handover and the secondary cell group change,
when satisfaction of the first execution condition is detected and satisfaction of the second execution condition is not detected when the timer expires through the monitoring, the second base station is a target master node, and the terminal performs the conditional handover, and
when satisfaction of the second execution condition is detected and satisfaction of the first execution condition is not detected when the timer expires through the monitoring, the second base station is a target secondary node, and the terminal performs the secondary cell group change.

5. The method of claim 1, wherein performing the monitoring comprises:
detecting radio quality changes related to at least one candidate base station;
performing measurement reporting to the first base station; and
receiving, from the first base station, reconfiguration information related to the conditional handover and the secondary cell group change.

6. The method of claim 1, wherein when the operation type is the second mode, the conditional handover or the secondary cell group change is performed sequentially based on the order in which the first execution condition and the second execution condition are satisfied.

7. The method of claim 6, wherein when satisfaction of the first execution condition is detected through the monitoring, the method further comprises:
connecting with the second base station based on the conditional handover; and
transmitting, to the second base station, monitoring status information related to the second execution condition,
wherein the second base station is a target master node.

8. The method of claim 6, wherein when satisfaction of the second execution condition is detected through the monitoring, the method further comprises:
connecting with the second base station based on the secondary cell group change; and
transmitting, to the second base station, monitoring status information related to the first execution condition,
wherein the second base station is a target secondary node.

9. The method of claim 1, further comprising transmitting a third message to the first base station based on the first message,
wherein the first message includes a list of operation types that can be selected by the terminal and priorities between the operation types, and
wherein the third message includes information about the operation type selected by the terminal.

10. The method of claim 9, wherein the first message is an RRC (radio resource control) reconfiguration message, and the third message is an RRC reconfiguration complete message.

11. The method of claim 1, wherein the first message includes information about the operation type selected by the first base station.

12. The method of claim 1, further comprising transmitting, to the first base station, a fourth message including information about the operation type selected by the terminal,
wherein the configuration information is determined based on the fourth message.

13. The method of claim 1, wherein the operation type is indicated through an index value.

14. A method of operating a first base station in a wireless communication system, comprising:
transmitting a first message including configuration information related to conditional handover and secondary cell group change to a terminal;
allocating resources related to the conditional handover and the secondary cell group change; and
performing at least one of the conditional handover or the secondary cell group change based on an operation type, wherein the operation type includes a first mode in which the conditional handover and the secondary cell group change are operated simultaneously and a second mode in which the conditional handover and the secondary cell group change are operated sequentially.

15. The method of claim 14, further comprising:
receiving measurement reports related to radio quality changes of at least one candidate base station from the terminal;
performing reconfiguration related to the conditional handover and the secondary cell group change based on the measurement reports; and
transmitting, to the terminal, information related to the reconfiguration.

16. The method of claim 14, further comprising receiving a third message from the terminal in response to the first message,
wherein the first message includes a list of operation types that can be selected by the terminal and priorities between the operation types, and
wherein the third message includes information about the operation type selected by the terminal.

17. The method of claim 14, wherein the first message includes information about the operation type selected by the first base station.

18. The method of claim 14, further comprising receiving, from the terminal, a fourth message including information about the operation type selected by the terminal,
wherein the configuration information is determined based on the fourth message.

19. A method of operating a second base station in a wireless communication system, comprising:
receiving, from a first base station, information related to resources and paths for conditional handover and secondary cell group change;
receiving, from a terminal, a second message including results of monitoring;
performing a random access procedure with the terminal based on the second message; and
transmitting a handover complete message to the first base station,
wherein the results of monitoring are information indicating whether a first execution condition for the conditional handover and a second execution condition for the secondary cell group change are satisfied.

20. The method of claim 19, wherein when the results of monitoring indicate satisfaction of the first execution condition and satisfaction of the second execution condition, the method further comprises transmitting, to a target secondary node, a message indicating that the conditional handover and the secondary cell group change have been successfully performed,
wherein the first base station is a source master node and the second base station is a target master node.
